(19) United States
(12) Patent Application Publication
(10) Pub. No.: US 2006/0004941 A1
(43) Pub. Date: Jan. 5, 2006

(54) Method, system, and program for accessesing a virtualized data structure table in cache

(76) Inventors: Hemal V. Shah, Austin, TX (US); Ashish V. Choubal, Austin, TX (US); Gary Y. Tsao, Austin, TX (US); Arturo L. Arizpe, Wimberley, TX (US); Sarita P. Saraswat, Chandler, AZ (US)

Correspondence Address: KONRAD RAYNES & VICTOR, LLP;Suite 210, 315 S. Beverly Drive, Beverly Hills, CA, 90212, US

(21) Appl. No.: 10/882,557

(22) Filed: Jun. 30, 2004

(51) Int. Cl. G06F 12/08

(52) U.S. Cl. 711/3; 711/206

(57) ABSTRACT

Provided are a method, system, and program for caching a virtualized data structure table. In one embodiment, an input/output (I/O) device has a cache subsystem for a data structure table which has been virtualized. As a consequence, the data structure table cache may be addressed using a virtual address or index. For example, a network adapter may maintain an address translation and protection table (TPT) which has virtually contiguous data structures but not necessarily physically contiguous data structures in system memory. TPT entries may be stored in a cache and addressed using a virtual address or index. Mapping tables may be stored in the cache as well and addressed using a virtual address or index.

### RELATED CASES

METHOD, SYSTEM, AND PROGRAM FOR MANAGING MEMORY FOR DATA TRANSMISSION THROUGH A NETWORK, (attorney docket P17143), Ser. No. 10/683,941, filed Oct. 9, 2003; METHOD, SYSTEM, AND PROGRAM FOR MANAGING VIRTUAL MEMORY, (attorney docket P17601), Ser. No. 10/747,920, filed Dec. 29,2003; METHOD, SYSTEM, AND PROGRAM FOR UTILIZING A VIRTUALIZED DATA STRUCTURE TABLE, (attorney docket P19013), Ser. No. ______, filed ______; and MESSAGE CONTEXT BASED TCP TRANSMISSION, (attorney docket P18331), Ser. No. ______, filed ______.

### BACKGROUND

1. Description of Related Art

In a network environment, a network adapter on a host computer, such as an Ethernet controller, Fibre Channel controller, etc., will receive Input/Output (I/O) requests or responses to I/O requests initiated from the host computer. Often, the host computer operating system includes a device driver to communicate with the network adapter hardware to manage I/O requests to transmit over a network. The host computer may also utilize a protocol which packages data to be transmitted over the network into packets, each of which contains a destination address as well as a portion of the data to be transmitted. Data packets received at the network adapter are often stored in a packet buffer. A transport protocol layer can process the packets received by the network adapter that are stored in the packet buffer, and access any I/O commands or data embedded in the packet.

For instance, the computer may employ the TCP/IP (Transmission Control Protocol/Internet Protocol) to encode and address data for transmission, and to decode and access the payload data in the TCP/IP packets received at the network adapter. IP specifies the format of packets, also called datagrams, and the addressing scheme. TCP is a higher level protocol which establishes a connection between a destination and a source and provides a byte-stream, reliable, full-duplex transport service. Another protocol, Remote Direct Memory Access (RDMA) on top of TCP provides, among other operations, direct placement of data at a specified memory location at the destination.

A device driver, application or operating system can utilize significant host processor resources to handle network transmission requests to the network adapter. One technique to reduce the load on the host processor is the use of a TCP/IP Offload Engine (TOE) in which TCP/IP protocol related operations are carried out in the network adapter hardware as opposed to the device driver or other host software, thereby saving the host processor from having to perform some or all of the TCP/IP protocol related operations. Similarly, an RDMA-enabled NIC (RNIC) offloads RDMA and transport related operations from the host processor(s).

The operating system of a computer typically utilizes a virtual memory space which is often much larger than the memory space of the physical memory of the computer. FIG. 1 shows an example of a virtual memory space 50 and a short term physical memory space 52. The memory space of a long term physical memory such as a hard drive is indicated at 54. The operating system of the computer uses the virtual memory address space 50 to keep track of the actual locations of the portions 10a, 10b and 10c of data such as a datastream 10. Thus, portions 50a, 50b of the virtual memory address space 50 are mapped to the actual physical memory addresses of the physical memory space 52 in which the data portions 10a, 10b, respectively are stored. Furthermore, a portion 50c of the virtual memory address space 50 is mapped to the physical memory addresses of the long term hard drive memory space 54 in which the data portion 10c is stored. A blank portion 50d represents an unassigned or unmapped portion of the virtual memory address space 50.

FIG. 2 shows an example of a typical system translation and protection table (TPT) 60 which the operating system utilizes to map virtual memory addresses to real physical memory addresses with protection at the process level. Thus, the virtual memory address of the virtual memory space 50a may start at virtual memory address 0X1000, for example, which is mapped to a physical memory address 8AEF000, for example of the physical memory space 52. In known systems, portions of the virtual memory space 50 may be assigned to a device or software module for use by that module so as to provide memory space for buffers

In some known designs, an Input/Output (I/O) device such as a network adapter or a storage controller may have the capability of directly placing data into an application buffer or other memory area. A Remote Direct Memory Access (RDMA) enabled Network Interface Card (RNIC) is an example of an I/O device which can perform direct data placement. An RNIC can support defined operations (also referred to as “semantics”) including RDMA Write, RDMA Read and Send/Receive, for memory to memory data transfers across a network.

The address of the application buffer which is the destination of the RDMA operation is frequently carried in the RDMA packets in some form of a buffer identifier and a virtual address or offset. The buffer identifier identifies which buffer the data is to be written to or read from. The virtual address or offset carried by the packets identifies the location within the identified buffer for the specified direct memory operation.

In order to perform direct data placement, an I/O device typically maintains its own translation and protection table (TPT), an example of which is shown at 70 in FIG. 3. The device TPT 70 contains data structures 72a, 72b, 72c . . . 72n, each of which is used to control access to a particular buffer as identified by an associated buffer identifier of the buffer identifiers 74a, 74b, 74c . . . 74n. The device TPT 70 further contains data structures 76a, 76b, 76c . . . 76n, each of which is used to translate the buffer identifier and virtual address or offset into physical memory addresses of the particular buffer identified by the associated buffer identifier 74a, 74b, 74c . . . 74n. Thus, for example, the data structure 76a of the TPT 70 is used by the I/O device to perform address translation for the buffer identified by the identifier 74a. Similarly, the data structure 72a is used by the I/O device to perform protection checks for the buffer identified by the buffer identifier 74a. The address translation and protection checks may be performed prior to direct data placement of the payload contained in a packet received from the network or prior to sending the data out on the network.

In order to facilitate high-speed data transfer, a device TPT such as the TPT 70 is typically managed by the I/O device and the driver software for the device. A device TPT can occupy a relatively large amount of memory. As a consequence, a TPT is frequently resident in system memory. The I/O device may maintain a cache of a portion of the device TPT to reduce access delays. The TPT cache may be accessed using the physical addresses of the TPT in system memory.

Notwithstanding, there is a continued need in the art to improve the performance of memory usage in data transmission and other operations.

### BRIEF DESCRIPTION OF THE DRAWINGS

Referring now to the drawings in which like reference numbers represent corresponding parts throughout:

FIG. 1 illustrates prior art virtual and physical memory addresses of a system memory in a computer system;

FIG. 2 illustrates a prior art system virtual to physical memory address translation and protection table;

FIG. 3 illustrates a prior art translation and protection table for an I/O device;

FIG. 4 illustrates one embodiment of a computing environment in which aspects of the description provided herein are embodied;

FIG. 5 illustrates a prior art packet architecture;

FIG. 6 illustrates one embodiment of a cache subsystem for a virtualized data structure table for an I/O device in accordance with aspects of the description;

FIG. 7 illustrates one embodiment of a data structure table virtual memory address space which is mapped to portions of a system memory address space;

FIG. 8 illustrates caching of data structure table entries in a cache of the subsytem of FIG. 6;

FIG. 9 illustrates one embodiment of mapping tables for accessing the virtualized data structure table of FIG. 7;

FIGS. 10a and 10b illustrate embodiments of data structures for the mapping tables of FIG. 9;

FIG. 10c illustrates an embodiment of a virtual address for addressing the virtualized data structure table of FIG. 7;

FIG. 11 illustrates an example of values for a data structure for the mapping tables of FIG. 6;

FIG. 12 illustrates one embodiment of operations performed to obtain data structure table entries from the cache of the subsystem of FIG. 6 or system memory;

FIG. 13 illustrates a more detailed embodiment of operations performed to obtain data structure table entries corresponding to a buffer from the cache of the subsystem of FIG. 6 or system memory; and

FIG. 14 illustrates an architecture that may be used with the described embodiments.

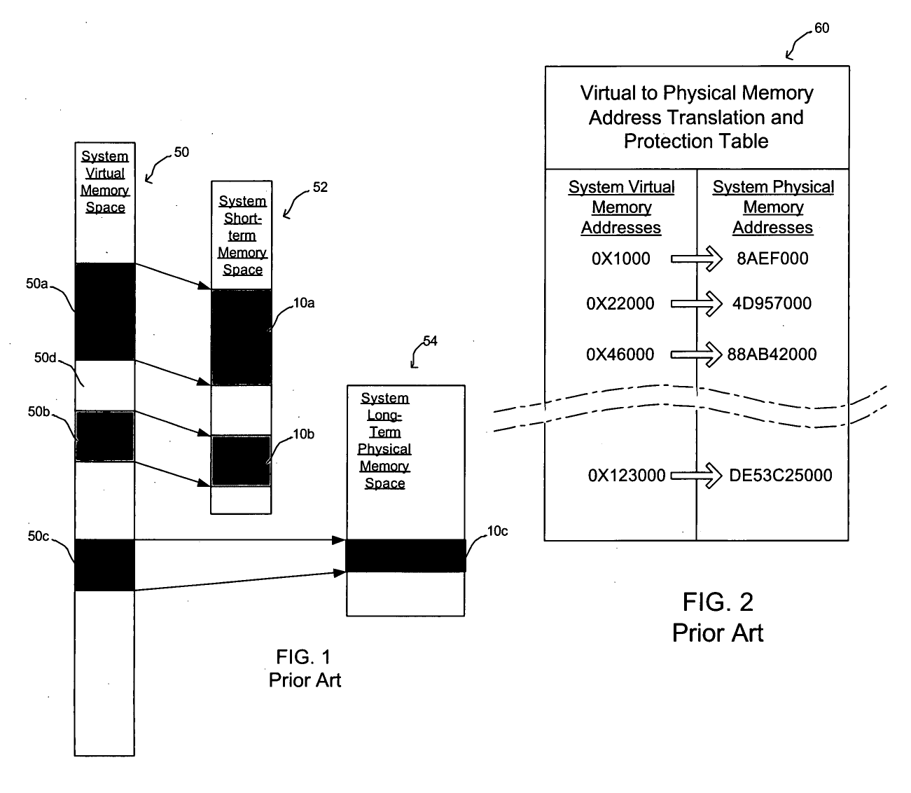

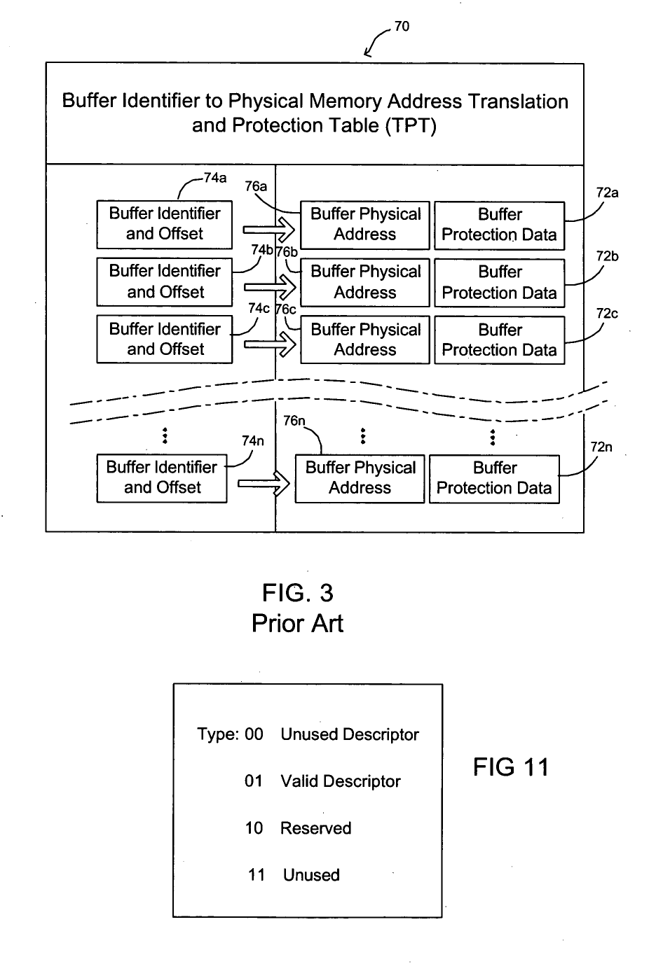

### DETAILED DESCRIPTION OF THE ILLUSTRATED EMBODIMENTS

In the following description, reference is made to the accompanying drawings which form a part hereof and which illustrate several embodiments of the present disclosure. It is understood that other embodiments may be utilized and structural and operational changes may be made without departing from the scope of the present description.

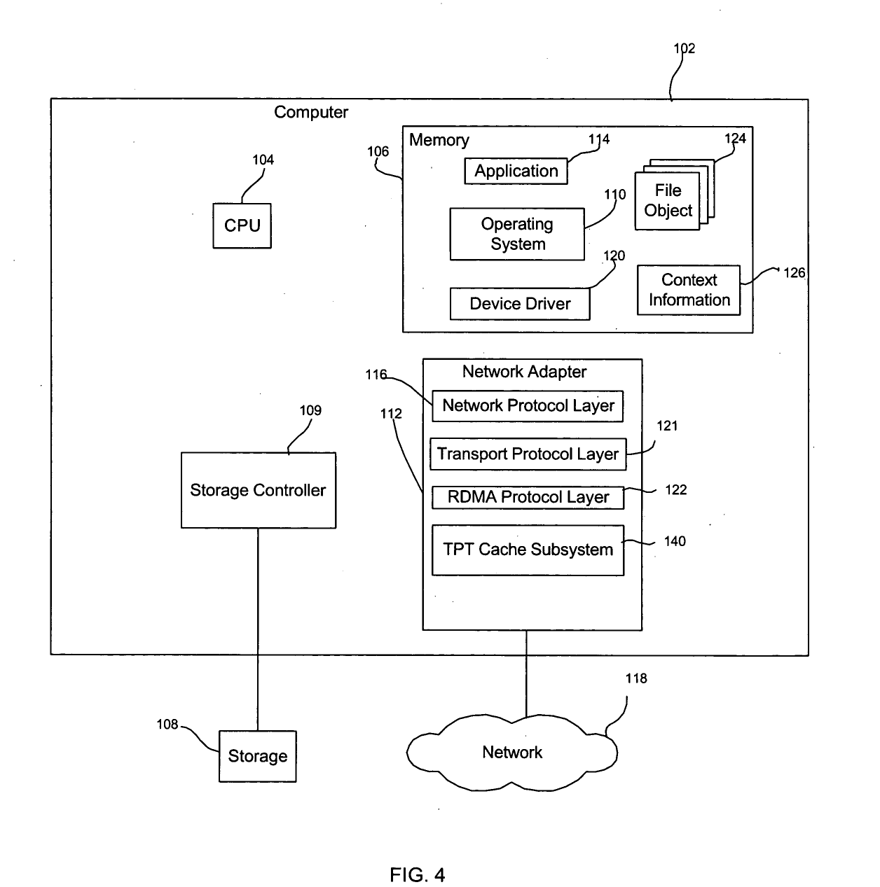

FIG. 4 illustrates a computing environment in which aspects of described embodiments may be employed. A computer 102 includes one or more central processing units (CPU) 104 (only one is shown), a memory 106, nonvolatile storage 108, a storage controller 109, an operating system 110, and a network adapter 112. An application 114 executes on a CPU 104, resides in memory 106 and is capable of transmitting and receiving packets from a remote computer. The content residing in memory 106 may be cached in accordance with known caching techniques. The computer 102 may comprise any computing device known in the art, such as a mainframe, server, personal computer, workstation, laptop, handheld computer, telephony device, network appliance, virtualization device, storage controller, storage controller, etc. Any CPU 104 and operating system 110 known in the art may be used. Programs and data in memory 106 may be swapped into storage 108 as part of memory management operations.

The storage controller 109 controls the reading of data from and the writing of data to the storage 108 in accordance with a storage protocol layer. The storage protocol may be any of a number of known storage protocols including Redundant Array of Independent Disks (RAID), High Speed Serialized Advanced Technology Attachment (SATA), parallel Small Computer System Interface (SCSI), serial attached SCSI, etc. Data being written to or read from the storage 108 may be cached in a cache in accordance with known caching techniques. The storage controller may be integrated into the CPU chipset, which can include various controllers including a system controller, peripheral controller, memory controller, hub controller, I/O bus controller, etc.

The network adapter 112 includes a network protocol layer 116 to send and receive network packets to and from remote devices over a network 118. The network 118 may comprise a Local Area Network (LAN), the Internet, a Wide Area Network (WAN), Storage Area Network (SAN), etc. Embodiments may be configured to transmit data over a wireless network or connection, such as wireless LAN, Bluetooth, etc. In certain embodiments, the network adapter 112 and various protocol layers may employ the Ethernet protocol over unshielded twisted pair cable, token ring protocol, Fibre Channel protocol, Infiniband, etc., or any other network communication protocol known in the art. The network adapter controller may be integrated into the CPU chipset, which, as noted above, can include various controllers including a system controller, peripheral controller, memory controller, hub controller, I/O bus controller, etc

A device driver 120 executes on a CPU 104, resides in memory 106 and includes network adapter 112 specific commands to communicate with a network controller of the network adapter 112 and interface between the operating system 110, applications 114 and the network adapter 112. The network controller can embody the network protocol layer 116 and can control other protocol layers including a data link layer and a physical layer which includes hardware such as a data transceiver.

In certain embodiments, the network controller of the network adapter 112 includes a transport protocol layer 121 as well as the network protocol layer 116. For example, the network controller of the network adapter 112 can employ a TCP/IP offload engine (TOE), in which many transport layer operations can be performed within the network adapter 112 hardware or firmware, as opposed to the device driver 120 or host software.

The transport protocol operations include packaging data in a TCP/IP packet with a checksum and other information and sending the packets. These sending 7. operations are performed by an agent which may be embodied with a TOE, a network interface card or integrated circuit, a driver, TCP/IP stack, a host processor or a combination of these elements. The transport protocol operations also include receiving a TCP/IP packet from over the network and unpacking the TCP/IP packet to access the payload data. These receiving operations are performed by an agent which, again, may be embodied with a TOE, a network interface card or integrated circuit, a driver, TCP/IP stack, a host processor or a combination of these elements.

The network layer 116 handles network communication and provides received TCP/IP packets to the transport protocol layer 121. The transport protocol layer 121 interfaces with the device driver 120 or an operating system 110 or an application 114, and performs additional transport protocol layer operations, such as processing the content of messages included in the packets received at the network adapter 112 that are wrapped in a transport layer, such as TCP, the Internet Small Computer System Interface (iSCSI), Fibre Channel SCSI, parallel SCSI transport, or any transport layer protocol known in the art. The TOE of the transport protocol layer 121 can unpack the payload from the received TCP/IP packet and transfer the data to the device driver 120, an application 114 or the operating system 110.

In certain embodiments, the network controller and network adapter 112 can further include one or more RDMA protocol layers 122 as well as the transport protocol layer 121. For example, the network adapter 112 can employ an RDMA offload engine, in which RDMA layer operations are performed within the network adapter 112 hardware or firmware, as opposed to the device driver 120 or other host software.

Thus, for example, an application 114 transmitting messages over an RDMA connection can transmit the message through the RDMA protocol layers 122 of the network adapter 112. The data of the message can be sent to the transport protocol layer 121 to be packaged in a TCP/IP packet before transmitting it over the network 118 through the network protocol layer 116 and other protocol layers including the data link and physical protocol layers.

The memory 106 further includes file objects 124, which also may be referred to as socket objects, which include information on a connection to a remote computer over the network 118. The application 114 uses the information in the file object 124 to identify the connection. The application 114 may use the file object 124 to communicate with a remote system. The file object 124 may indicate the local port or socket that will be used to communicate with a remote system, a local network (IP) address of the computer 102 in which the application 114 executes, how much data has been sent and received by the application 114, and the remote port and network address, e.g., IP address, with which the application 114 communicates. Context information 126 comprises a data structure including information the device driver 120, operating system 110 or an application 114, maintains to manage requests sent to the network adapter 112 as described below.

In the illustrated embodiment, the CPU 104 programmed to operate by the software of memory 106 including one or more of the operating system 110, applications 114, and device drivers 120 provides a host which interacts with the network adapter 112. Accordingly, a data send and receive agent includes t he transport protocol layer 121 and the network protocol layer 116 of the network interface 112. However, the data send and receive agent may be embodied with a TOE, a network interface card or integrated circuit, a driver, TCP/IP stack, a host processor or a combination of these elements.

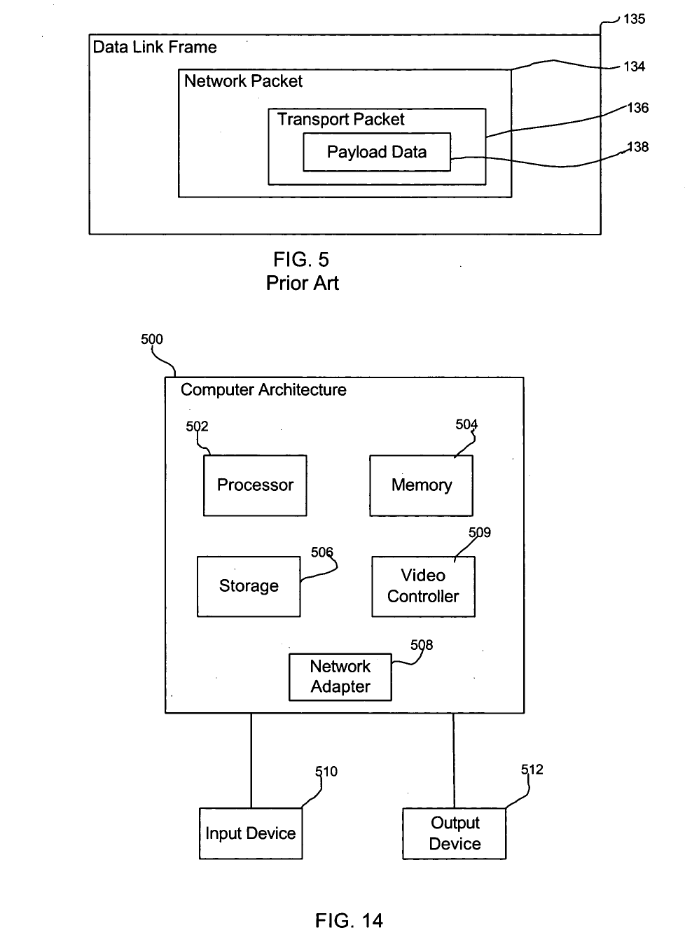

FIG. 5 illustrates a format of a network packet 134 received at or transmitted by the network adapter 112. A data link frame 135 is embodied in a format understood by the data link layer, such as 802.11 Ethernet. Details on this Ethernet protocol are described in “IEEE std. 802.11,” published 1999-2003. An Ethernet frame may include additional Ethernet components, such as a header and an error checking code (not shown). The data link frame 135 includes the network packet 134, such as an IP datagram. The network packet 134 is embodied in a format understood by the network protocol layer 116, such as such as the IP protocol. A transport packet 136 is included in the network packet 134. The transport packet 136 is capable of being processed by the transport protocol layer 121, such as the TCP. The packet may be processed by other layers in accordance with other protocols including Internet Small Computer System Interface (iSCSI) protocol, Fibre Channel SCSI, parallel SCSI transport, etc. The transport packet 136 includes payload data 138 as well as other transport layer fields, such as a header and an error checking code. The payload data 138 includes the underlying content being transmitted, e.g., commands, status and/or data. The driver 120, operating system 110 or an application 114 may include a layer, such as a SCSI driver or layer, to process the content of the payload data 138 and access any status, command s and/or data therein. Details on the Ethernet protocol are described in “IEEE std. 802.3,” published Mar. 8, 2002.

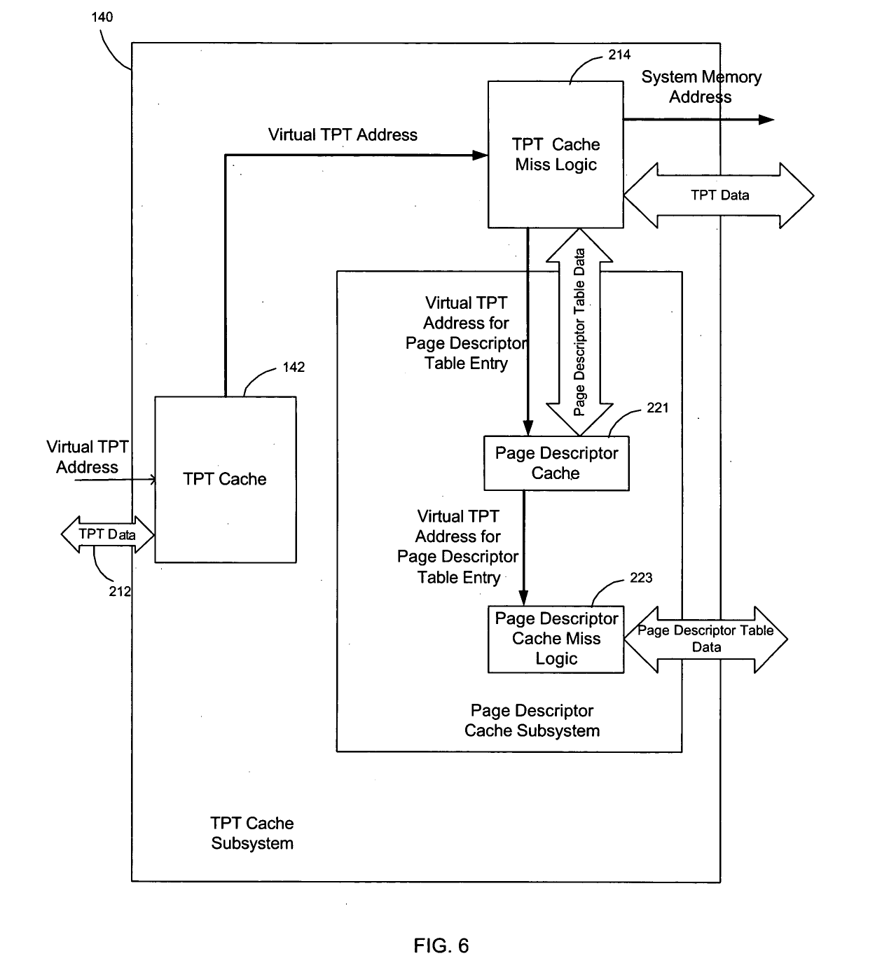

In accordance with one aspect of the description provided herein, an I/O device has a cache subsystem for a data structure table which has been virtualized. As a consequence, the data structure table cache may be addressed using a virtual address or index. For example, the network adapter 112 maintains an address translation and protection table (TPT) which has virtually contiguous data structures but not necessarily physically contiguous data structures in system memory. FIG. 6 shows an example of a TPT cache subsystem 140 of the network adapter 112, which has a cache 142 in which TPT entries may be addressed within the cache using a TPT virtual address. In some applications, a virtual address may have fewer bits than a physical address, thereby permitting cache design simplification, in some applications.

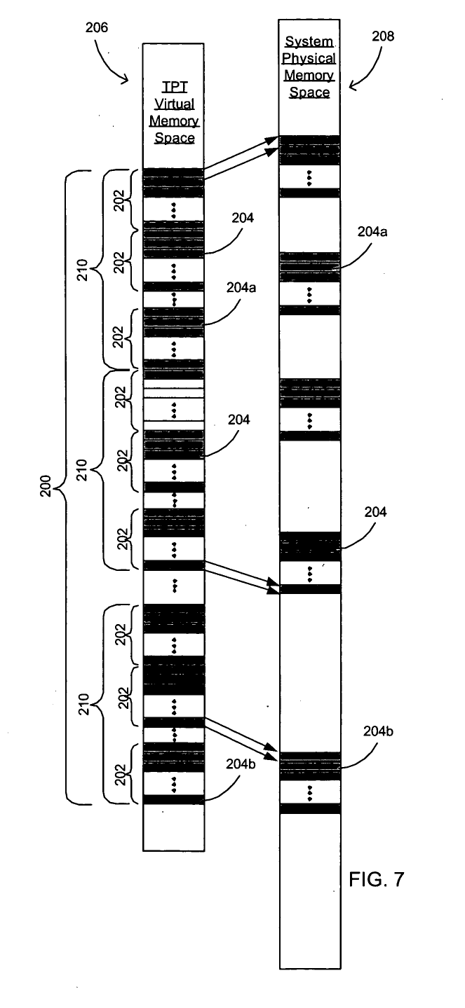

FIG. 7 shows an example of a virtualized TPT table 200 having virtually contiguous pages or blocks 202 of TPT entries 204, each TPT entry 204 containing one or more data structures. The TPT entry blocks 202 are contiguous to each other in a TPT virtual address space 206 but may be disjointed, that is, not contiguous to each other in the system physical memory space 208 in which the TPT entry blocks 202 reside. However, in the illustrated embodiment, the TPT entries 204 of each block 202 of entries may be contiguous, that is, have contiguous system memory addresses in the system physical memory space 208 in which the TPT entry blocks 202 reside.

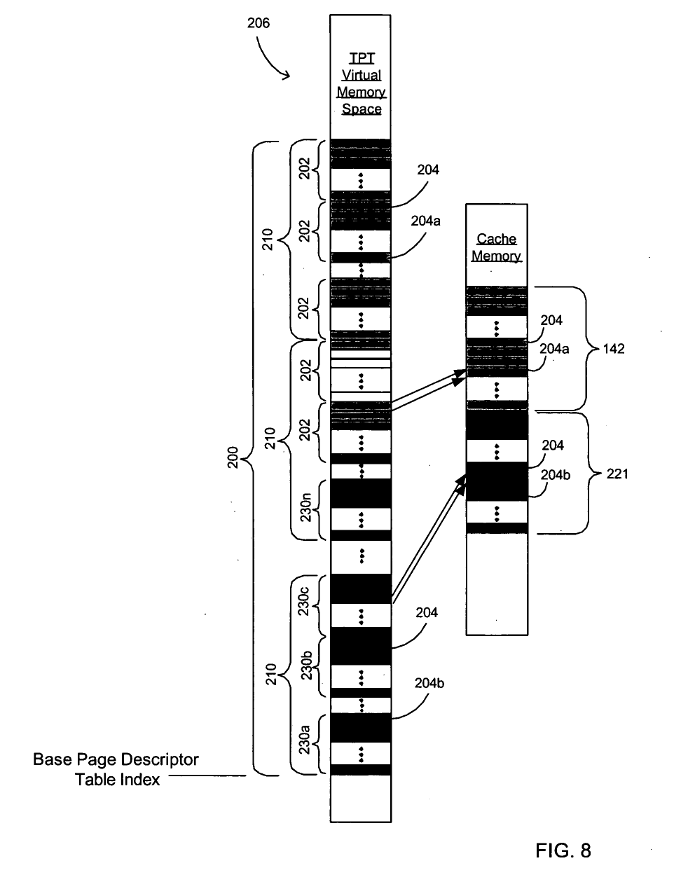

Selected TPT entries 204 may be cached in the TPT cache 142 as shown in FIG. 8. The selection of the TPT entries 204 for caching may be made using known heuristic techniques.

Both the TPT entries 204 residing in the system memory space 208 and the TPT entries 204 cached in the TPT cache 142 may be accessed in a virtually contiguous manner. The virtual address space for TPT may be per I/O device and it can be disjoint from the virtual address space used by the applications, the operating system, the drivers and other I/O devices. In the illustrated embodiment, the TPT 200 is subdivided at a first level into a plurality of virtually contiguous units or segments 210 as shown in FIGS. 7 and 8. Each unit or segment 210 is in turn subdivided at a second level into a plurality of physically contiguous subunits or subsegments 202. The subsegments 202 are referred to herein as “pages” or “blocks” 202. Each page or block 202 is in turn subdivided at a third level into a plurality of virtually contiguous TPT entries 204, each TPT entry 204 containing one or more data structures. It is appreciated that the TPT 200 may be subdivided at a greater number or lesser number of hierarchal levels.

In the illustrated embodiment, each of the segments 210 of the TPT 200 is of equal size, each of the pages 202 of the TPT 200 is of equal size and each of the TPT entries 204 is of equal size. However, it is appreciated that TPT segments of unequal sizes, TPT pages of unequal sizes and TPT entries of unequal sizes may also be utilized.

The data structures contained within at least some of the TPT entries 204 contain data which identifies the physical address of a buffer and protection data for that buffer. These TPT entries 204 containing buffer physical address and protection data are referenced in FIGS. 7 and 8 as TPT entries 204a. Selected TPT entries 204a containing buffer physical address and protection data are cached in the TPT cache 142 of the TPT cache subsystem 140.

Accordingly, to access the physical address and protection data structures of a buffer, the virtual address of a TPT entry 204a containing one or more of those data structures is applied by a component of the network adapter 112 to the TPT cache 142. If the addressed TPT entry 204a has been cached within the cache 142, that is, there is a cache “hit”, the addressed data structures are provided on a TPT data bus 212 from the cache 142.

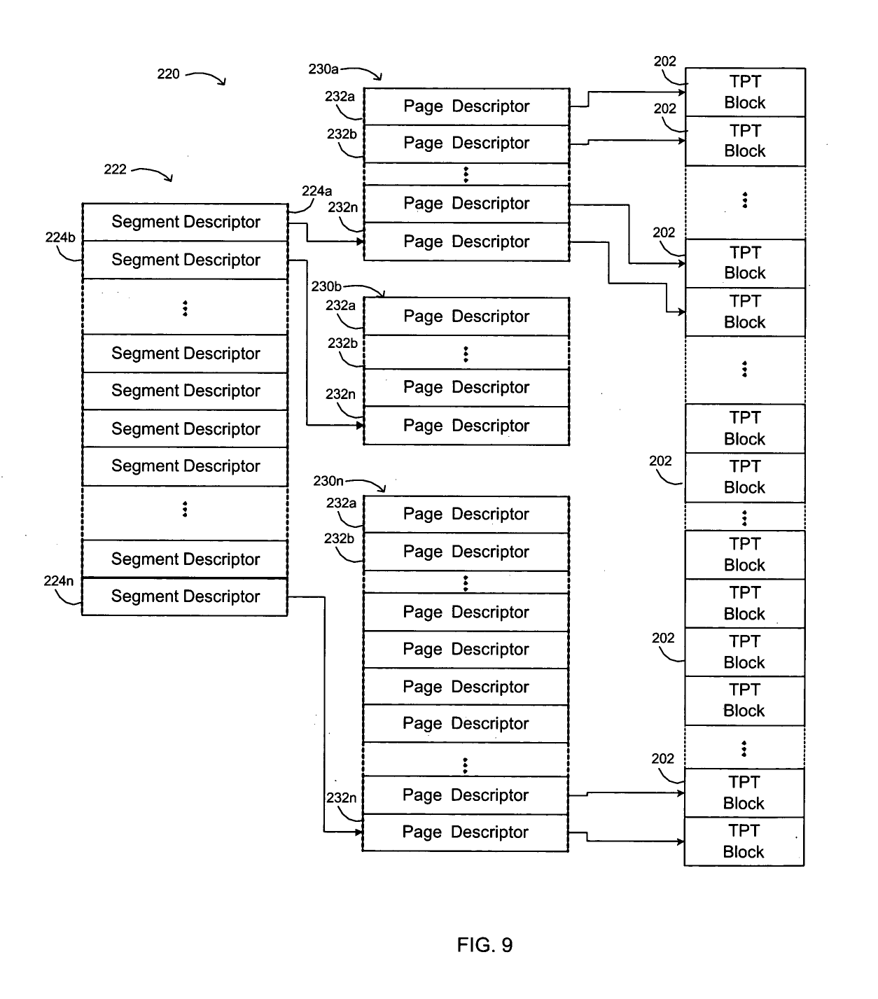

If the addressed TPT entry 204a has not been cached within the cache 142, that is, there is a cache “miss”, the virtual address of the TPT entry 204a containing the data structure is applied to a TPT cache miss logic 214 which uses the virtual address to access the TPT entry 204a within the TPT table 200 resident in system memory. In the illustrated embodiment, the TPT 200 may be accessed in a virtually contiguous manner utilizing a set of hierarchal data structure tables, an example of which are shown schematically at 220 in FIG. 9. These tables 220 may be used to convert virtual addresses of the TPT entries 204 to physical addresses of the TPT entries 204.

In accordance with another aspect of the present description, at least a portion of the hierarchal data structure tables 220 may reside within the TPT 200 itself. Accordingly, the data structures contained within at least some of the TPT entries 204 contain data which embody at least some of the hierarchal data structure tables 220. These TPT entries 204 which are also hierarchal data structure table entries are referenced in FIGS. 7 and 8 as TPT entries 204b.

In the same manner as the buffer physical address and protection TPT entries 204a may be cached in the TPT cache 142, the hierarchal table TPT entries 204b may be cached in the TPT cache subsystem 140 in a cache portion indicated at 221. Similarly, the hierarchal table TPT entries 204b may be addressed in the cache 221 using the virtual addresses of the hierarchal table TPT entries 204b within the TPT 200. If there is a cache miss, the virtual address of the TPT entry 204b containing the hierarchal table data structure is applied to a cache miss logic 223 which uses the virtual address to access the TPT entry 204b within the TPT table 200 resident in system memory.

As previously mentioned, the TPT 200 may be accessed in a virtually contiguous manner utilizing the set of hierarchal data structure tables 220 shown in FIG. 9. These tables 220 may be used to convert virtual addresses of the TPT entries 204a or 204b to physical addresses of the TPT entries 204 as explained below.

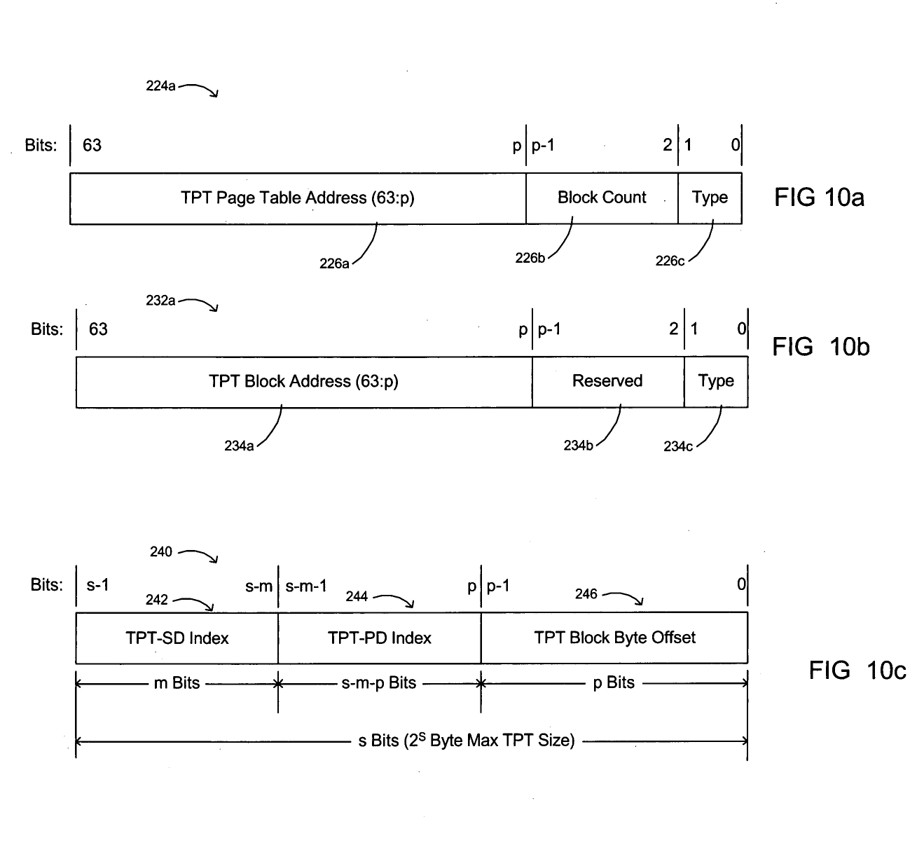

A first level data structure table 222, referred to herein as a segment descriptor table 222, of hierarchal data structure tables 220, has a plurality of segment descriptor entries 224a, 224b . . . 224n. Each segment descriptor entry 224a, 224b . . . 224n contains data structures, an example of which is shown in FIG. 10a at 224a. In this example, each of the segment descriptor entries 224a, 224b . . . 224n contains a plurality of data structures 226a, 226b and 226c which define characteristics of one of the segments 210 of the TPT 200. More particularly, each of the segment descriptor entries 224a, 224b . . . 224n describe a second level hierarchal data structure table referred to herein as a page descriptor table. Each page descriptor table is one of a plurality of page descriptor tables 230a, 230b . . . 230n (FIG. 9) of hierarchal data structure tables 220.

Each page descriptor table 230a, 230b . . . 230n has a plurality of page descriptor entries 232a, 232b . . . 232n. Each page descriptor entry 232a, 232b . . . 232n contains data structures, an example of which is shown in FIG. 10b at 232a. In this example, each of the page descriptor entries 232a, 232b . . . 232n contains a plurality of data structures 234a, 234b and 234c which define characteristics of one of the pages or blocks 202 of a segment 210 of the TPT 200.

In the illustrated embodiment, the page descriptor tables 230a, 230b . . . 230n reside within the TPT 200. Hence, each page descriptor entry 232a, 232b . . . 232n is a TPT entry 204b of the TPT 200 and contains a plurality of data structures 234a, 234b and 234c which define characteristics of one of the pages or blocks 202 of a segment 210 of the TPT 200. The device driver 120 which stores the page descriptor tables 230a, 230b . . . 230n within the TPT 200, can provide to the I/O device the base virtual address or base page descriptor Table Index which marks the beginning of the page descriptor tables 230a, 230b . . . 230n within the TPT 200. It is appreciated that some or all of the page descriptor tables 230a, 230b . . . 230n may reside within the I/O device itself in a manner similar to the segment descriptor table 222.

In the illustrated embodiment, if the number of TPT entries 204 in the TPT table 200 is represented by the variable 2^{s}, the TPT entries 204 may be accessed in a virtually contiguous manner utilizing a virtual address comprising s address bits as shown at 240 in FIG. 10c, for example. If the number of segments 210 into which the TPT table 200 is subdivided is represented by the variable 2^{m}, each segment 210 can describe up to 2^{(s-m)} bytes of the TPT virtual memory space 206.

In the illustrated embodiment, the segment descriptor table 222 may reside in memory located within the I/O device. Also, a set of bits indicated at 242 of the virtual address 240 may be utilized to define an index, referred to herein as a TPT segment descriptor index, to identify a particular segment descriptor entry 224a, 224b . . . 224n of the segment descriptor table 222. In the illustrated embodiment, the s-m most significant bits of the s bits of the TPT virtual address 240 may be used to define the TPT segment descriptor index.

Once identified by the TPT segment descriptor index 242 of the TPT virtual address 240, the data structure 226a (FIG. 10a) of the identified segment descriptor entry 224a, 224b . . . 224n, can provide the physical address of one of the plurality of page descriptor tables 230a, 230b . . . 230n (FIG. 9). A second data structure 226b of the identified segment descriptor entry 224a, 224b . . . 224n can specify how large the descriptor table of data structure 226a is by, for example, providing a block count. A third data structure 226c of the identified segment descriptor entry 224a, 224b . . . 224n can provide additional information concerning the segment 210 such as whether the particular segment 210 is being used or is valid, as set forth in the type table of FIG. 11.

Also, a second set of bits indicated at 244 of the virtual address 240 may be utilized to define a second index, referred to herein as a TPT page descriptor index, to identify a particular page descriptor entry 232a, 232b . . . 232n of the page descriptor table 232a, 232b . . . 232n identified by the physical address of the data structure 226a (FIG. 10a) of the segment descriptor entry 224a, 224b . . . 224n identified by the TPT segment descriptor index 242 of the TPT virtual address 240. In the illustrated embodiment, the next s-m-p most significant bits of the s bits of the TPT virtual address 240 may be used to define the TPT segment descriptor index 244.

Once identified by the physical address contained in the data structure 226a of the TPT segment descriptor table entry identified by the TPT segment descriptor index 242 of the TPT virtual address 240, and the TPT segment descriptor index 244 of the TPT virtual address 240, the data structure 234a (FIG. 10b) of the identified page descriptor entry 232a, 232b . . . 232n, can provide the physical address of one of the plurality of TPT pages or blocks 202 (FIG. 7). A second data structure 226b of the identified page descriptor entry 232a, 232b . . . 232n may be reserved. A third data structure 234c of the identified page descriptor entry 232a, 232b . . . 232n can provide additional information concerning the TPT block or page 202 such as whether the particular TPT block or page 202 is being used or is valid, as set forth in the type table of FIG. 11.

Also, a third set of bits indicated at 246 of the virtual address 240 may be utilized to define a third index, referred to herein as a TPT block byte offset, to identify a particular TPT entry 204 of the TPT page or block 202 identified by the physical address of the data structure 234a (FIG. 10b) of the page descriptor entry 232a, 232b . . . 232n identified by the TPT page descriptor index 244 of the TPT virtual address 240. In the illustrated embodiment, the p least significant bits of the s bits of the TPT virtual address 240 may be used to define the TPT block byte offset 246 to identify a particular byte of 2^{P} bytes in a page or block 202 of bytes.

In the illustrated embodiment, the device driver 120 allocates memory blocks to construct the TPT 200. The size and number of the allocated memory blocks, as well as the size and number of the segments 110 in which the data structure table will be subdivided, will be a function of the operating system 110, the computer system 102 and the needs of the I/O device.

Once allocated and pinned, the memory blocks may be populated with data structure entries such as the TPT entries 204. Each TPT entry 204 of the TPT 200 may include one or more data structures which contain buffer protection data for a particular buffer, and virtual addresses or physical addresses of the particular buffer. In the illustrated embodiment, the bytes of the TPT entries 204 within each allocated memory block may be physically contiguous although the TPT blocks or pages 202 of TPT entries 204 of the TPT 200 may be disjointed or noncontiguous. In one embodiment, the TPT blocks or pages 202 of TPT entries 204 of the TPT 200 are each located at 2^{P} physical address boundaries where each TPT block or page 202 comprises 2^{P} bytes. Also, in one embodiment, where the system memory has 64 bit addresses, for example, each TPT entry will be 8-byte aligned. It is appreciated that other boundaries and other addressing schemes may be used as well.

Also, the data structure table subsegment mapping tables such as the page descriptor tables 230a, 230b . . . 230n (FIG. 9), may be populated with data structure entries such as the page descriptor entries 232a, 232b . . . 232n. As previously mentioned, each page descriptor entry may include a data structure such as the data structure 234a (FIG. 10b) which contains the physical address of a TPT page or block 202 of TPT entries 204 of the TPT 200, as well as a data structure such as the data structure 234c which contains type information for the page or block 202.

The page descriptor tables 230a, 230b . . . 230n (FIG. 9) may be resident either in memory such as the system memory 106 or on the I/O device. If the page descriptor tables 230a, 230b . . . 230n are resident on the I/O device, the I/O address of the page descriptor tables 230a, 230b . . . 230n may be mapped by the device driver 120 and then initialized by the device driver 120. If the page descriptor tables 230a, 230b . . . 230n are resident in the system memory 106, they can be addressed using system physical addresses, for example. In an alternative embodiment, the page descriptor tables 230a, 230b . . . 230n they can be stored in the TPT 200 itself in a virtually contiguous region of the TPT 200. In this embodiment, the base TPT virtual address of the page descriptor tables 230a, 230b . . . 230n may be initialized by the device driver 120 and communicated to the I/O device such as the adapter 112. The I/O device can then use this base address to access the page descriptor tables 230a, 230b . . . 230n.

Also, the data structure table segment mapping table such as the segment descriptor table 222 (FIG. 9), may be populated with data structure entries such as the segment descriptor entries 224a, 224b . . . 224n. As previously mentioned, each segment descriptor entry may include a data structure such as the data structure 226a (FIG. 10a) which contains the physical address of one of the page descriptor table 230a, 230b . . . 230n. Each segment descriptor entry may further include a data structure 226b which describes the size of the page descriptor table, as well as a data structure such as the data structure 224c which contains type information for the page descriptor table.

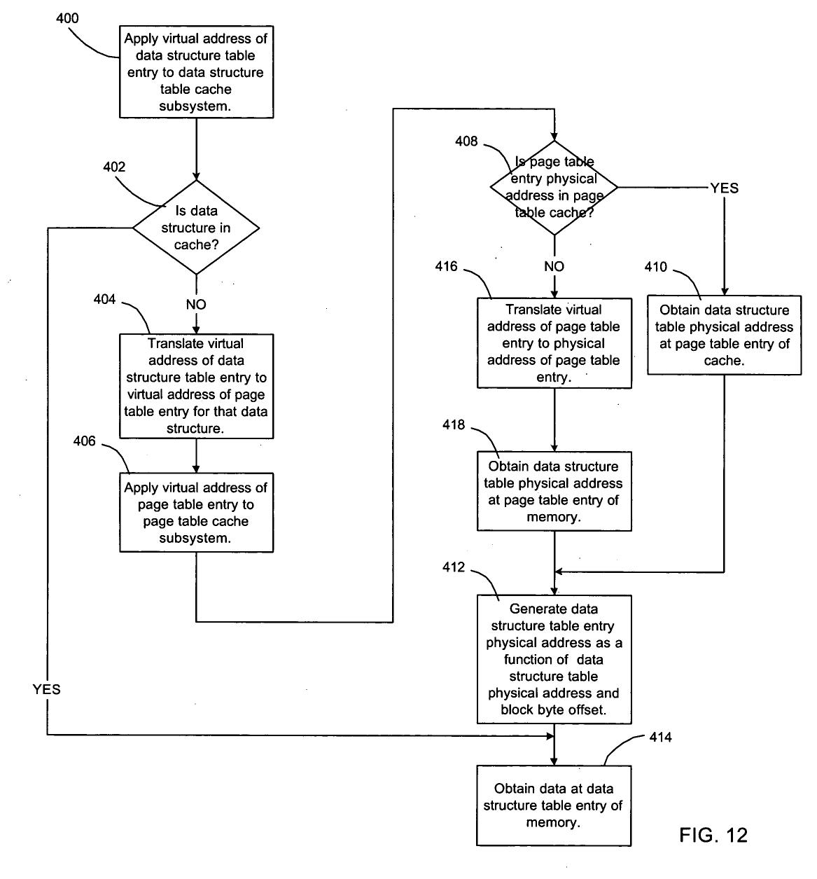

FIG. 12 shows an example of operations of an I/O device such as the adapter 112, to obtain a data structure from a data structure table such as the TPT 200. The I/O device applies (block 400) a virtual address of the data structure table entry, such as an entry 204a, for example, to a data structure cache subsystem such as the subsystem 140, for example. The virtual address may be generated by a component of the I/O device as a function of a buffer identifier or some other destination identifier received by the I/O device.

A determination is made (block 402) as to whether the data structure addressed by the virtual address is within a cache, such as the cache 142 of the subsystem 140, for example. If so, that is, there is a cache hit, the data structure identified by the applied virtual address and stored in the cache may be supplied to the requesting I/O device component on a data bus such as the TPT data bus 212.

If there is a cache miss, the virtual address of the data structure table entry is translated (block 404) by logic such as the TPT Cache Miss Logic 214, for example, to the virtual address of the hierarchal table entry. As previously mentioned, at least a portion of the hierarchal table entries may reside in the TPT 200 itself. Thus, in one embodiment, the virtual address of the data structure table entry 204a within the TPT 200 may be readily shifted to the virtual address of the corresponding hierarchal table entry 204b within the TPT 200 using the Base Page Descriptor Table Index supplied by the device driver 120 discussed above.

The I/O device applies (block 406) the virtual address of the hierarchal table entry, such as an entry 204b, for example, to a hierarchal table cache such as the page descriptor table cache 221, for example. A determination is made (block 408) as to whether the data structure of the hierarchal table entry addressed by the hierarchal table entry virtual address is within the cache. If so, that is, there is a cache hit, the data structure identified by the applied virtual address and stored in the hierarchal table cache provides (block 410) the physical address of that portion of the data structure table containing the data structure table entry addressed by the virtual address supplied by the I/O device component. For example, a page descriptor table entry 204b of the TPT 200 if read in a cache hit, provides the physical address of the TPT block 202 containing the data structure addressed by the virtual address supplied by the network adapter 112 component.

The I/O device generates (block 412) a data structure table entry physical address as a finction of the data structure table physical address and any offset defined by the virtual address supplied by the I/O device component. For example, the physical address of the TPT block 202 containing the data structure addressed by the virtual address supplied by the network adapter 112 component, may be combined with the block byte offset defined by the virtual TPT address portion 246 to generate the physical address of the TPT entry 204a addressed by the virtual TPT address supplied by the network adapter 112 component. This physical address may be used to obtain (block 414) the data structure of the TPT entry 204a residing in the system memory and addressed by the TPT virtual address supplied to the requesting I/O device component.

If there is a cache miss, that is, the data structure of the hierarchal table addressed by the virtual address is not within the hierarchal table cache, the virtual address of that hierarchal table entry is translated (block 416) to the physical address of the hierarchal table entry. In the illustrated embodiment, this translation may be accomplished by applying the segment descriptor table index 242 of the page descriptor table entry virtual address to select the particular entry 224a, 224b . . . 224n of the segment descriptor table 222. The selected segment descriptor table entry 224a, 224b . . . 224n contains a data structure 226a from which the physical address of a page table 230a . . . 230n may be obtained. This physical address may be combined with the page descriptor index 244 of the virtual address of that hierarchal table entry to select the particular entry 232a . . . 232n of the page table. The selected page table entry 232a . . . 232n contains a data structure 234a from which the physical address of the TPT block 202 containing the data structure addressed by the virtual address supplied by the network adapter 112 component, may be obtained (block 418).

Again, the I/O device generates (block 412) a data structure table entry physical address as a function of the data structure table physical address and any offset defined by the virtual address supplied by the I/O device component. For example, the physical address of the TPT block 202 containing the data structure addressed by the virtual address supplied by the network adapter 112 component, may be combined with the block byte offset defined by the virtual TPT address portion 246 to generate the physical address of the TPT entry 204a addressed by the virtual TPT address supplied by the network adapter 112 component. This physical address may be used to obtain (block 414) the data structure of the TPT entry 204a residing in the system memory and addressed by the TPT virtual address supplied to the requesting I/O device component.

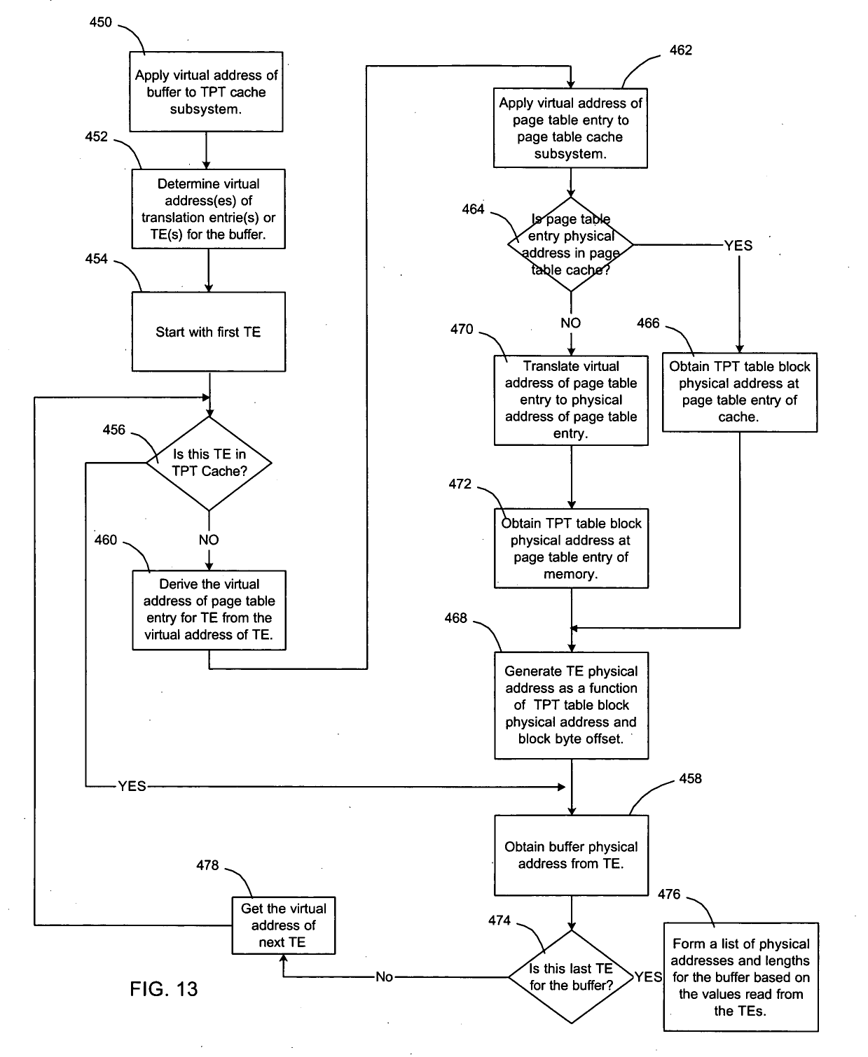

FIG. 13 shows a more detailed example of operations of an I/O device such as the adapter 112, to obtain a data structure from a data structure table such as the TPT 200 in response to receipt of a buffer identifier and offset for an RDMA memory operation. The buffer identifier is converted to a virtual address in the manner described above. The buffer virtual address points to a data structure table entry, such as an entry 204a, for example, which contains a data structure which identifies one or more virtual addresses of other data structure table entries 204a, which in turn identify one or more physical addresses in system memory of the buffer.

The I/O device applies (block 450) the buffer virtual address to a data structure cache 142. The virtual address or addresses of the translation entries for the buffer are then determined (block 452). If the virtual addresses of the translation entries (TE(s)) for the buffer are not in the cache 142, the virtual addresses may be obtained from one or more data structures stored in the system memory in the manner described above in connection with FIG. 12.

Once the virtual addresses of the translation entries for the buffer have been obtained, starting (block 454) with first translation entry, the virtual address of the first translation entry may be applied to the TPT cache 142 to determine (block 456) whether this translation entry is in the cache 142. If so, that is there is a cache hit, the data structure identified by the applied virtual address and stored in the cache may be supplied to the requesting I/O device component on a data bus such as the TPT data bus 212. In this manner, a buffer physical address (block 458) may be obtained from the data structure of this translation entry.

If there is a cache miss, the virtual address of the page table entry for the translation entry is derived (block 460) from the virtual address of the translation entry by logic such as the TPT Cache Miss Logic 214, for example. As previously mentioned, at least a portion of the hierarchal table entries may reside in the TPT 200 itself. Thus, in one embodiment, the virtual address of the data structure table entry 204a within the TPT 200 may be readily shifted to the virtual address of the corresponding hierarchal table entry 204b within the TPT 200 using the Base Page Descriptor Table Index supplied by the device driver 120 discussed above.

The I/O device applies (block 462) the virtual address of the hierarchal table entry, such as an entry 204b, for example, to a hierarchal table cache such as the page descriptor table cache 221, for example. A determination is made (block 464) as to whether the data structure of the hierarchal table entry addressed by the hierarchal table entry virtual address is within the cache 221. If so, that is, there is a cache hit, the data structure identified by the applied virtual address and stored in the hierarchal table cache provides (block 466) the physical address of that portion of the data structure table containing the translation entry. For example, a page descriptor table entry 204b of the TPT 200 if read from the page descriptor cache, provides the physical address of the TPT block 202 containing the data structure of the translation entry for the buffer.

The I/O device generates (block 468) a translation entry physical address as a function of the data structure table physical address and any offset defined by the virtual address of the translation entry of the buffer. For example, the physical address of the TPT block 202 containing the data structure addressed by the buffer translation entry virtual address, may be combined with the block byte offset defined by the virtual TPT address portion 246 to generate the physical address of the TPT translation entry 204a addressed by the buffer translation entry virtual TPT address. This physical address may be used to obtain (block 458) the data structure of the TPT entry 204a residing in the system memory and addressed by the buffer translation entry TPT virtual address.

If there is a cache miss, that is, the data structure of the hierarchal table addressed by the virtual address is not within the hierarchal table cache, the virtual address of that hierarchal table entry is translated (block 470) to the physical address of the hierarchal table entry. In the illustrated embodiment, this translation may be accomplished by applying the segment descriptor table index 242 of the page descriptor table entry virtual address to select the particular entry 224a, 224b . . . 224n of the segment descriptor table 222. The selected segment descriptor table entry 224a, 224b . . . 224n contains a data structure 226a from which the physical address of a page table 230a . . . 230n may be obtained. This physical address may be combined with the page descriptor index 244 of the virtual address of that hierarchal table entry to select the particular entry 232a . . . 232n of the page table. The selected page table entry 232a . . . 232n contains a data structure 234a from which the physical address of the TPT block 202 containing the data structure addressed by the virtual address of the buffer translation entry, may be obtained (block 472).

Again, the I/O device generates (block 468) a buffer translation entry physical address as a function of the data structure table physical address and any offset defined by the buffer translation entry virtual address. For example, the physical address of the TPT block 202 containing the data structure addressed by the buffer translation entry virtual address, may be combined with the block byte offset defined by the virtual TPT address portion 246 to generate the physical address of the buffer translation entry 204a of the TPT addressed by the buffer translation entry virtual TPT address. This physical address may be used to obtain (block 458) the data structure of the TPT translation entry 204a residing in the system memory and addressed by the buffer translation entry virtual address.

A determination (block 474) is made as to whether the last translation entry for the buffer has been converted to a physical address. If so, a list of physical addresses and lengths for the buffer based on the values read from the translation entries is formed (block 476). If there are additional buffer translation entries, the virtual address of each additional translation entry is obtained (block 478) and applied (blocks 456-472) to the cache to obtain the physical address and length values for each translation entry for the buffer from cache, or from the system memory if not in cache, as described above.

Additional Embodiment Details

The described techniques for managing memory may be embodied as a method, apparatus or article of manufacture using standard programming and/or engineering techniques to produce software, firmware, hardware, or any combination thereof. The term “article of manufacture” as used herein refers to code or logic embodied in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and nonvolatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are embodied may further be accessible through a transmission media or from a file server over a network. In such cases, the article of manufacture in which the code is embodied may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present description, and that the article of manufacture may comprise any information bearing medium known in the art.

In the described embodiments, certain operations were described as being performed by the operating system 110, system host 130, device driver 120, or the network interface 112. In alterative embodiments, operations described as performed by one of these may be performed by one or more of the operating system 110, device driver 120, or the network interface 112. For example, memory operations described as being performed by the driver may be performed by the host.

In the described embodiments, a transport protocol layer 121 and one or more RDMA protocol layers 122 were embodied in the network adapter 112 hardware. In alternative embodiments, the transport protocol layer may be embodied in the device driver or host memory 106.

In the described embodiments, the packets are transmitted from a network adapter to a remote computer over a network. In alternative embodiments, the transmitted and received packets processed by the protocol layers or device driver may be transmitted to a separate process executing in the same computer in which the device driver and transport protocol driver execute. In such embodiments, the network adapter is not used as the packets are passed between processes within the same computer and/or operating system.

In certain embodiments, the device driver and network adapter embodiments may be included in a computer system including a storage controller, such as a SCSI, Integrated Drive Electronics (IDE), Redundant Array of Independent Disk (RAID), etc., controller, that manages access to a nonvolatile storage device, such as a magnetic disk drive, tape media, optical disk, etc. In alternative embodiments, the network adapter embodiments may be included in a system that does not include a storage controller, such as certain hubs and switches.

In certain embodiments, the device driver and network adapter embodiments may be embodied in a computer system including a video controller to render information to display on a monitor coupled to the computer system including the device driver and network adapter, such as a computer system comprising a desktop, workstation, server, mainframe, laptop, handheld computer, etc. Alternatively, the network adapter and device driver embodiments may be embodied in a computing device that does not include a video controller, such as a switch, router, etc.

In certain embodiments, the network adapter may be configured to transmit data across a cable connected to a port on the network adapter. Alternatively, the network adapter embodiments may be configured to transmit data over a wireless network or connection, such as wireless LAN, Bluetooth, etc.

The illustrated logic of FIGS. 12-13 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

Details on the TCP protocol are described in “Internet Engineering Task Force (IETF) Request for Comments (RFC) 793,” published September 1981, details on the IP protocol are described in “Internet Engineering Task Force (IETF) Request for Comments (RFC) 791, published September 1981, and details on the RDMA protocol are described in the technology specification “Architectural Specifications for RDMA over TCP/IP” Version 1.0 (October 2003).

An I/O device in accordance with embodiments described herein may include a network controller or adapter or a storage controller or other devices utilizing a cache.

FIG. 14 illustrates one embodiment of a computer architecture 500 of the network components, such as the hosts and storage devices shown in FIG. 4. The architecture 500 may include a processor 502 (e.g., a microprocessor), a memory 504 (e.g., a volatile memory device), and storage 506 (e.g., a nonvolatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a manner known in the art. The architecture further includes a network adapter 508 to enable communication with a network, such as an Ethernet, a Fibre Channel Arbitrated Loop, etc. Further, the architecture may, in certain embodiments, include a video controller 509 to render information on a display monitor, where the video controller 509 may be embodied on a video card or integrated on integrated circuit components mounted on the motherboard. As discussed, certain of the network devices may have multiple network cards or controllers. An input device 510 is used to provide user input to the processor 502, and may include a keyboard, mouse, pen-stylus, microphone, touch sensitive display screen, or any other activation or input mechanism known in the art. An output device 512 is capable of rendering information transmitted from the processor 502, or other component, such as a display monitor, printer, storage, etc. Details on the Fibre Channel architecture are described in the technology specification “Fibre Channel Framing and Signaling Interface”, document no. ISO/IEC AWI 14165-25

The network adapter 508 may embodied on a network card, such as a Peripheral Component Interconnect (PCI) card, PCI-express, or some other I/O card, or on integrated circuit components mounted on the motherboard. Details on the PCI architecture are described in “PCI Local Bus, Rev. 2.3”, published by the PCI-SIG.

The foregoing description of various embodiments has been presented for the purposes of illustration and description. It is not intended to be exhaustive or to limit to the precise form disclosed. Many modifications and variations are possible in light of the above teaching.

What is claimed is:

1. A method, comprising:
applying to a cache, a virtual address of an entry of a table of virtually contiguous data structures stored in memory, each data structure containing data describing a buffer;
obtaining said data of said addressed data structure table entry from said cache if present in said cache; and
if said addressed data structure table entry is not present in said cache:
translating said data structure table virtual address to a physical address of said data structure table entry in said memory; and
obtaining said data of said addressed data structure table entry at said physical address in memory.

2. The method of claim 1 wherein said virtual address to physical address translating includes translating said virtual address of said data structure table entry to a virtual address of an entry of a table of contiguous page descriptors, each page descriptor including a physical address of a page of contiguous data structure entries in memory;
applying said page descriptor table entry virtual address to a cache of page descriptor table entries; and
obtaining a physical address of a page of contiguous data structure entries from said cache of page descriptor table entries if present in said cache of page descriptor table entries.

3. The method of claim 2 wherein said virtual address to physical address translating includes generating a data structure table entry physical address as a function of said physical address of said page of contiguous data structure entries and a block byte offset portion of said virtual address of said data structure table entry.

4. The method of claim 2 wherein said virtual address to physical address translating further includes:
if said addressed page descriptor table entry is not present in said cache of page descriptor table entries:
translating said page descriptor table entry virtual address to a page descriptor table entry physical address; and
obtaining said physical address of a page of contiguous data structure entries at said page descriptor table entry physical address in memory.

5. The method of claim 1 wherein said data structure includes a plurality of physical addresses of a buffer, said method further comprising transferring data at said physical addresses of said buffer.

6. The method of claim 4 wherein said data structure includes a virtual address of a second entry of said table of virtually contiguous data structures stored in said memory, and wherein said second data structure entry includes a plurality of physical addresses of a buffer, said method further comprising transferring data at said buffer physical addresses.

7. The method of claim 6 further comprising:
applying said second entry virtual address to said cache;
obtaining said buffer physical addresses from said cache if present in said cache; and
if said addressed data structure table second entry is not present in said cache:
translating said second entry virtual address to a physical address of said data structure table second entry in said memory; and
obtaining said buffer physical addresses from said data structure table second entry in memory.

8. The method of claim 7 wherein said virtual address to physical address translating of said second entry virtual address includes translating said second entry virtual address to a virtual address of a second entry of said table of contiguous page descriptors;
applying said page descriptor table second entry virtual address to said cache of page descriptor table entries; and
obtaining a physical address of a second page of contiguous data structure entries from said cache of page descriptor table entries if present in said cache of page descriptor table entries.

9. The method of claim 8 wherein said virtual address to physical address translating of said second entry virtual address includes generating a data structure table second entry physical address as a function of said physical address of said second page of contiguous data structure entries and a block byte offset portion of said second entry virtual address of said data structure table.

10. The method of claim 9 wherein said virtual address to physical address translating of said second entry virtual address of said data structure table further includes:
if said addressed page descriptor table second entry is not present in said cache of page descriptor table entries:
translating said page descriptor table second entry virtual address to a page descriptor table second entry physical address; and
obtaining said physical address of a second page of contiguous data structure entries at said page descriptor table second entry physical address in memory.

11. The method of claim 1 wherein said table is a translation and protection table.

12. The method of claim 1 further comprising converting a buffer identifier of a destination address of a Remote Direct Memory Access (RDMA) memory operation to said virtual address of an entry of said table of virtually contiguous data structures stored in memory.

13. The method of claim 1 further comprising converting at least one of an offset and a virtual address within a buffer targeted by a Remote Direct Memory Access (RDMA) operation to said virtual address of an entry of said table of virtually contiguous data structures stored in memory.

14. An article comprising a storage medium, the storage medium comprising machine readable instructions stored thereon to:
apply to a cache, a virtual address of an entry of a table of virtually contiguous data structures stored in memory, each data structure containing data describing a buffer;
obtain said data of said addressed data structure table entry from said cache if present in said cache; and
if said addressed data structure table entry is not present in said cache:
translate said data structure table virtual address to a physical address of said data structure table entry in said memory; and
obtain said data of said addressed data structure table entry at said physical address in memory.

15. The article of claim 14 wherein said virtual address to physical address translating includes translating said virtual address of said data structure table entry to a virtual address of an entry of a table of contiguous page descriptors, each page descriptor including a physical address of a page of contiguous data structure entries in memory;
applying said page descriptor table entry virtual address to a cache of page descriptor table entries; and
obtaining a physical address of a page of contiguous data structure entries from said cache of page descriptor table entries if present in said cache of page descriptor table entries.

16. The article of claim 15 wherein said virtual address to physical address translating includes generating a data structure table entry physical address as a function of said physical address of said page of contiguous data structure entries and a block byte offset portion of said virtual address of said data structure table entry.

17. The article of claim 15 wherein said virtual address to physical address translating further includes:
if said addressed page descriptor table entry is not present in said cache of page descriptor table entries:
translating said page descriptor table entry virtual address to a page descriptor table entry physical address; and
obtaining said physical address of a page of contiguous data structure entries at said page descriptor table entry physical address in memory.

18. The article of claim 14 wherein said data structure includes a plurality of physical addresses of a buffer, and wherein the storage medium further comprises machine readable instructions stored thereon to transfer data at said physical addresses of said buffer.

19. The article of claim 17 wherein said data structure includes a virtual address of a second entry of said table of virtually contiguous data structures stored in said memory, and wherein said second data structure entry includes a plurality of physical addresses of a buffer, and wherein the storage medium further comprises machine readable instructions stored thereon to transfer data at said buffer physical addresses.

20. The article of claim 19 wherein the storage medium further comprises machine readable instructions stored thereon to:
apply said second entry virtual address to said cache;
obtain said buffer physical addresses from said cache if present in said cache; and
if said addressed data structure table second entry is not present in said cache:
translate said second entry virtual address to a physical address of said data structure table second entry in said memory; and
obtain said buffer physical addresses from said data structure table second entry in memory.

21. The article of claim 20 wherein said virtual address to physical address translating of said second entry virtual address includes translating said second entry virtual address to a virtual address of a second entry of said table of contiguous page descriptors;
applying said page descriptor table second entry virtual address to said cache of page descriptor table entries; and
obtaining a physical address of a second page of contiguous data structure entries from said cache of page descriptor table entries if present in said cache of page descriptor table entries.

22. The article of claim 21 wherein said virtual address to physical address translating of said second entry virtual address includes generating a data structure table second entry physical address as a finction of said physical address of said second page of contiguous data structure entries and a block byte offset portion of said second entry virtual address of said data structure table.

23. The article of claim 22 wherein said virtual address to physical address translating of said second entry virtual address of said data structure table further includes:
if said addressed page descriptor table second entry is not present in said cache of page descriptor table entries:
translating said page descriptor table second entry virtual address to a page descriptor table second entry physical address; and
obtaining said physical address of a second page of contiguous data structure entries at said page descriptor table second entry physical address in memory.

24. The article of claim 14 wherein said table is a translation and protection table.

25. The article of claim 14 wherein the storage medium further comprises machine readable instructions stored thereon to convert a buffer identifier of a destination address of a Remote Direct Memory Access (RDMA) memory operation to said virtual address of an entry of said table of virtually contiguous data structures stored in memory.

26. The article of claim 14 wherein the storage medium further comprises machine readable instructions stored thereon to convert at least one of an offset and a virtual address within a buffer targeted by a Remote Direct Memory Access (RDMA) operation to said virtual address of an entry of said table of virtually contiguous data structures stored in memory.

27. A system for use with a network, comprising:
at least one system memory which includes an operating system and a plurality of buffers;
a motherboard;
a processor mounted on the motherboard and coupled to the memory;
an expansion card coupled to said motherboard;
a network adapter mounted on said expansion card and having a cache; and
a device driver executable by the processor in the system memory for said network adapter wherein the device driver is adapted to store in said system memory a table of virtually contiguous data structures; and wherein the network adapter is adapted to:
apply to said cache, a virtual address of an entry of said table of virtually contiguous data structures stored in memory, each data structure containing data describing a buffer;
obtain said data of said addressed data structure table entry from said cache if present in said cache; and
if said addressed data structure table entry is not present in said cache:
translate said data structure table virtual address to a physical address of said data structure table entry in said memory; and
obtain said data of said addressed data structure table entry at said physical address in memory.

28. The system of claim 27 wherein said data structures include a table of contiguous page descriptors, each page descriptor including a physical address of a page of contiguous data structure entries in memory, said network adapter has a cache of page descriptor table entries, and wherein said virtual address to physical address translating includes translating said virtual address of said data structure table entry to a virtual address of an entry of said table of contiguous page descriptors;
applying said page descriptor table entry virtual address to said cache of page descriptor table entries; and
obtaining a physical address of a page of contiguous data structure entries from said cache of page descriptor table entries if present in said cache of page descriptor table entries.

29. The system of claim 28 wherein said virtual address of said data structure entry includes a block byte offset portion and wherein said virtual address to physical address translating includes generating a data structure table entry physical address as a function of said physical address of said page of contiguous data structure entries and said block byte offset portion of said virtual address of said data structure table entry.

30. The system of claim 28 wherein said virtual address to physical address translating further includes:
if said addressed page descriptor table entry is not present in said cache of page descriptor table entries:
translating said page descriptor table entry virtual address to a page descriptor table entry physical address; and
obtaining said physical address of a page of contiguous data structure entries at said page descriptor table entry physical address in memory.

31. The system of claim 27 wherein said data structure includes a plurality of physical addresses of one of said buffers, and wherein the network adapter is further adapted to transfer data at said physical addresses of said buffer.

32. The system of claim 30 wherein said data structure includes a virtual address of a second entry of said table of virtually contiguous data structures stored in said memory, and wherein said second data structure entry includes a plurality of physical addresses of one of said buffers, and wherein the network adapter is further adapted to transfer data at said buffer physical addresses.

33. The system of claim 32 wherein the network adapter is further adapted to:
apply said second entry virtual address to said cache;
obtain said buffer physical addresses from said cache if present in said cache; and
if said addressed data structure table second entry is not present in said cache:
translate said second entry virtual address to a physical address of said data structure table second entry in said memory; and
obtain said buffer physical addresses from said data structure table second entry in memory.

34. The system of claim 33 wherein said virtual address to physical address translating of said second entry virtual address includes translating said second entry virtual address to a virtual address of a second entry of said table of contiguous page descriptors;
applying said page descriptor table second entry virtual address to said cache of page descriptor table entries; and
obtaining a physical address of a second page of contiguous data structure entries from said cache of page descriptor table entries if present in said cache of page descriptor table entries.

35. The system of claim 34 wherein said second entry virtual address of said data structure table includes a block byte offset portion and wherein said virtual address to physical address translating of said second entry virtual address includes generating a data structure table second entry physical address as a function of said physical address of said second page of contiguous data structure entries and a block byte offset portion of said second entry virtual address of said data structure table.

36. The system of claim 35 wherein said virtual address to physical address translating of said second entry virtual address of said data structure table further includes:
if said addressed page descriptor table second entry is not present in said cache of page descriptor table entries:
translating said page descriptor table second entry virtual address to a page descriptor table second entry physical address; and
obtaining said physical address of a second page of contiguous data structure entries at said page descriptor table second entry physical address in memory.

37. The system of claim 27 wherein said table is a translation and protection table.

38. The system of claim 27 wherein a Remote Direct Memory Access (RDMA) memory operation includes a destination address which includes a buffer identifier and wherein the network adapter is further adapted to convert said buffer identifier of said destination address of said Remote Direct Memory Access (RDMA) memory operation to said virtual address of an entry of said table of virtually contiguous data structures stored in memory.

39. The system of claim 27 wherein a Remote Direct Memory Access (RDMA) memory operation targets a buffer having a location identified by at least one of an offset and a virtual address within the targeted buffer and wherein the network adapter is further adapted to convert at least one of said offset and virtual address within a buffer targeted by a Remote Direct Memory Access (RDMA) operation to said virtual address of an entry of said table of virtually contiguous data structures stored in memory.

40. A network controller for use with a processor, at least one system memory which is adapted to include a plurality of buffers and a device driver executable by the processor in the system memory for said network controller; said network controller comprising:
a cache; and
logic wherein the device driver is adapted to store in said system memory a table of virtually contiguous data structures, each data structure containing data describing a buffer; and wherein the logic is adapted to:
apply to said cache, a virtual address of an entry of said table of virtually contiguous data structures stored in memory;
obtain said data of said addressed data structure table entry from said cache if present in said cache; and
if said addressed data structure table entry is not present in said cache:
translate said data structure table virtual address to a physical address of said data structure table entry in said memory; and
obtain said data of said addressed data structure table entry at said physical address in memory.

41. The network controller of claim 40 wherein said data structures include a table of contiguous page descriptors, each page descriptor including a physical address of a page of contiguous data structure entries in memory, wherein said network controller further comprises a cache of page descriptor table entries, and wherein said virtual address to physical address translating includes translating said virtual address of said data structure table entry to a virtual address of an entry of said table of contiguous page descriptors;
applying said page descriptor table entry virtual address to said cache of page descriptor table entries; and
obtaining a physical address of a page of contiguous data structure entries from said cache of page descriptor table entries if present in said cache of page descriptor table entries.

42. The network controller of claim 41 wherein said virtual address of said data structure entry includes a block byte offset portion and wherein said virtual address to physical address translating includes generating a data structure table entry physical address as a function of said physical address of said page of contiguous data structure entries and said block byte offset portion of said virtual address of said data structure table entry.

43. The network controller of claim 41 wherein said virtual address to physical address translating further includes:
if said addressed page descriptor table entry is not present in said cache of page descriptor table entries:
translating said page descriptor table entry virtual address to a page descriptor table entry physical address; and
obtaining said physical address of a page of contiguous data structure entries at said page descriptor table entry physical address in memory.

44. The network controller of claim 40 wherein said data structure includes a plurality of physical addresses of one of said buffers, and wherein the network controller logic is further adapted to transfer data at said physical addresses of said buffer.

45. The network controller of claim 43 wherein said data structure includes a virtual address of a second entry of said table of virtually contiguous data structures stored in said memory, and wherein said second data structure entry includes a plurality of physical addresses of one of said buffers, and wherein the network controller logic is further adapted to transfer data at said buffer physical addresses.

46. The network controller of claim 45 wherein the network controller logic is further adapted to:
apply said second entry virtual address to said cache;
obtain said buffer physical addresses from said cache if present in said cache; and
if said addressed data structure table second entry is not present in said cache:
translate said second entry virtual address to a physical address of said data structure table second entry in said memory; and
obtain said buffer physical addresses from said data structure table second entry in memory.

47. The network controller of claim 46 wherein said virtual address to physical address translating of said second entry virtual address includes translating said second entry virtual address to a virtual address of a second entry of said table of contiguous page descriptors;
applying said page descriptor table second entry virtual address to said cache of page descriptor table entries; and
obtaining a physical address of a second page of contiguous data structure entries from said cache of page descriptor table entries if present in said cache of page descriptor table entries.

48. The network controller of claim 47 wherein said second entry virtual address of said data structure table includes a block byte offset portion and wherein said virtual address to physical address translating of said second entry virtual address includes generating a data structure table second entry physical address as a function of said physical address of said second page of contiguous data structure entries and a block byte offset portion of said second entry virtual address of said data structure table.

49. The network controller of claim 48 wherein said virtual address to physical address translating of said second entry virtual address of said data structure table further includes:
if said addressed page descriptor table second entry is not present in said cache of page descriptor table entries:
translating said page descriptor table second entry virtual address to a page descriptor table second entry physical address; and
obtaining said physical address of a second page of contiguous data structure entries at said page descriptor table second entry physical address in memory.

50. The network controller of claim 40 wherein said table is a translation and protection table.

51. The network controller of claim 40 wherein a Remote Direct Memory Access (RDMA) memory operation includes a destination address which includes a buffer identifier and wherein the network controller logic is further adapted to convert said buffer identifier of said destination address of said Remote Direct Memory Access (RDMA) memory operation to said virtual address of an entry of said table of virtually contiguous data structures stored in memory.

52. The network controller of claim 40 wherein a Remote Direct Memory Access (RDMA) memory operation targets a buffer having a location identified by at least one of an offset and a virtual address within the targeted buffer and wherein the network controller logic is further adapted to convert at least one of said offset and virtual address within a buffer targeted by a Remote Direct Memory Access (RDMA) operation to said virtual address of an entry of said table of virtually contiguous data structures stored in memory.
